(19) United States
(12) Patent Application Publication
(10) Pub. No.: US 2016/0150164 A1
(43) Pub. Date: May 26, 2016

(54) SYSTEM CONTROLLER, MULTI-CAMERA VIEW SYSTEM AND A METHOD OF PROCESSING IMAGES

(71) Applicants: MICHAEL ANDREAS STAUDENMAIER, MUNICH (DE); STEPHAN HERRMANN, MARKT SCHWABEN (DE); ROBERT CRISTIAN KRUTSCH, MUNICH (DE)

(72) Inventors: MICHAEL ANDREAS STAUDENMAIER, MUNICH (DE); STEPHAN HERRMANN, MARKT SCHWABEN (DE); ROBERT CRISTIAN KRUTSCH, MUNICH (DE)

(73) Assignee: FREESCALE SEMICONDUCTOR, INC., Austin, TX (US)

(21) Appl. No.: 14/551,615

(22) Filed: Nov. 24, 2014

(51) Int. Cl. H04N 5/262; B60R 1/00; H04N 5/265; H04N 5/247; H04N 5/232

(52) U.S. Cl. CPC H04N 5/2628; H04N 5/247; H04N 5/23229; H04N 5/265; B60R 1/00; B60R 2300/105; B60R 2300/303; B60R 2300/306

(57) ABSTRACT

A system controller controls a multi-camera view system for displaying an output image on a display. The output image is a view from a selected viewpoint. The system controller comprises an image resizing unit, a memory, and a processing unit. The image resizing unit receives the at least two input images captured by at least two cameras and is arranged to output to the memory at least two resized images, corresponding to the at least two input images, respectively. The image resizing unit resizes the at least two input images based on the selected viewpoint. The memory stores the two resized images. The processing unit is coupled to the memory and generates the output image from the at least two resized images.

### FIELD OF THE INVENTION

This invention relates to a system controller, a multi-camera view system, an automotive vehicle, a method of processing at least two input images, a computer program product and a non-transitory tangible computer readable storage medium.

### BACKGROUND OF THE INVENTION

A multi-camera view system is a system used for displaying an output image on a display by capturing two or more input images by respective two or more cameras. The output image may be e.g. used by a driver of an automotive vehicle to better estimate distances, presence of obstacles. The output image may be a view from a selected viewpoint.

In such multi-camera view systems, typically a dedicated processing unit deals with the processing of the two or more input images to provide the desired view. The dedicated processing unit typically accesses the two or more input images as captured by the cameras and processes these input images to generate the output image. Transfer of the input images from and/or to the dedicated processing unit is a cumbersome operation requiring relatively high transfer bandwidth and computing power.

### SUMMARY OF THE INVENTION

The present invention provides a system controller, a multi-camera view system, an automotive vehicle, a method of processing at least two images, a computer program product and a non-transitory tangible computer readable storage medium as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale. In the Figures, elements, which correspond to elements already described, may have the same reference numerals.

FIG. 1 schematically shows a first example of a multi-camera view system.

FIG. 2 schematically shows a second example of a multi-camera view system.

FIG. 3 schematically shows a third example of a multi-camera view system.

FIG. 4 shows a top view of an example of an automotive vehicle.

FIG. 5 schematically shows a flow diagram of a method of processing at least two input images.

FIG. 6 schematically shows a non-transitory tangible computer readable storage medium.

### DETAILED DESCRIPTION OF THE PREFERRED EMBODIMENTS

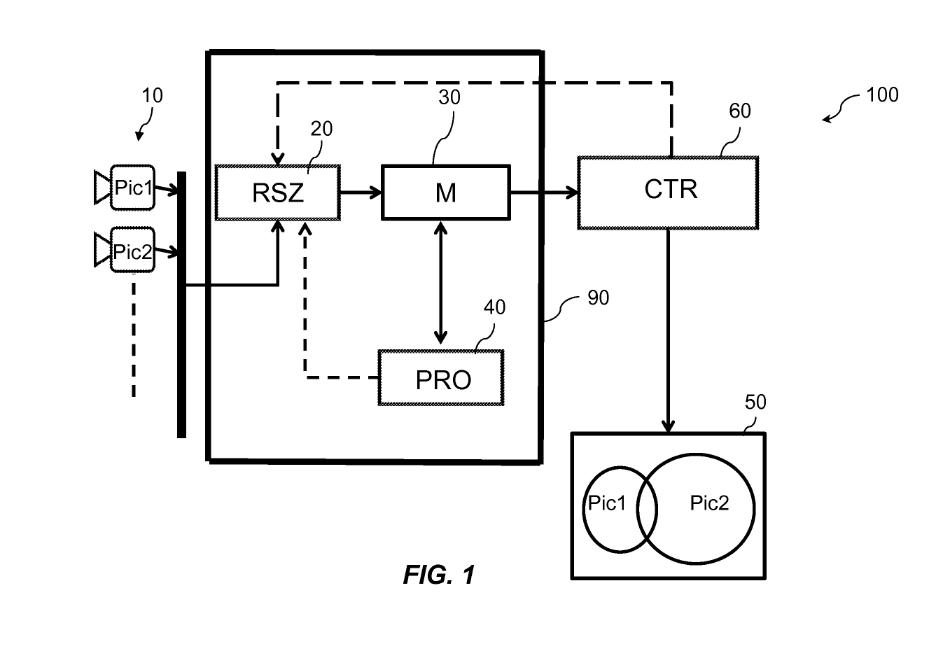

FIG. 1 schematically shows a first example of a multi-camera view system 100. The multi-camera view system 100 is suitable for displaying an output image by processing at least two input images. The multi-camera view system 100 comprises: a system controller 90 for controlling the multi-camera view system 100, at least two cameras 10, a display 50 and optionally a controlling unit 60.

The system controller 90 comprises an image resizing unit 20 coupled to the at least two cameras 10, a memory 30 coupled to the resizing unit 20, a processing unit 40 coupled to the memory 30.

The at least two cameras 10 are used to capture the at least two input images, respectively. The image resizing unit 20 has an input via which the image resizing unit 20 receives the at least two input images from the cameras 10. The image-resizing unit 20 is arranged to output at least two resized images corresponding to the at least two input images received from the cameras 10. The memory 30 stores the two resized images. The processing unit 40 generates the output image from the at least two resized images. The output image is outputted to the display 50, e.g. via the controlling unit 60. The display 50 displays the output image. The displayed output image is a view from a selected viewpoint. For example, the controlling unit 60 may select the viewpoint. The image resizing unit 20 is arranged to resize the at least two input images based on the selected viewpoint.

Resizing the at least two input images based on the selected viewpoint may occur in any manner specific for the specific implementation.

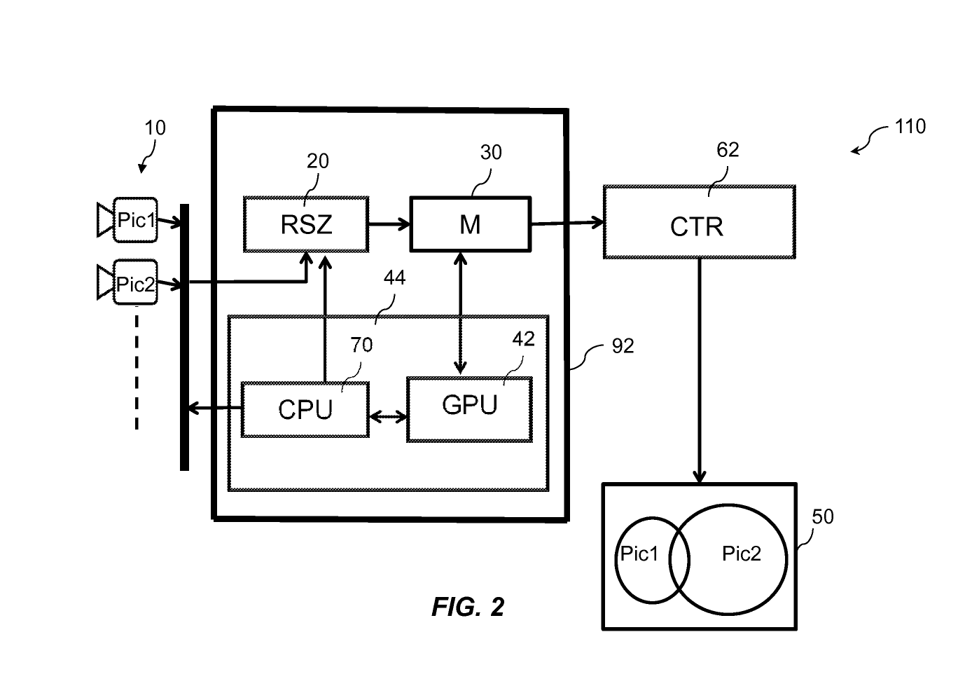

The dashed lines in FIG. 1 indicate two examples of two different paths to the image resizing unit 20. FIG. 2 shows a further example of a path to the image resizing unit 20.

In one example, the processing unit 40 is coupled to the image resizing unit 20. The processing unit 40 may be arranged to generate at least one resizing factor. The image resizing unit 20 receives the at least one resizing factor to resize the at least two input images based on the selected viewpoint.

In another example, the controlling unit 60 may be arranged to generate the at least one resizing factor based on the selected viewpoint. The image resizing unit 20 may be coupled to the controlling unit 60 for receiving the at least one resizing factor from the controlling unit 60 to resize the at least two input images.

FIG. 2 shows a second example of a multi-camera view system 110. The multi-camera view system 110 comprises a system controller 92, at least two cameras 10, a controlling unit 62 and a display 50. The system controller 92 differs from the system controller 90 described with reference to FIG. 1 in that the system controller 92 comprises a processing unit 44. The processing unit 44 comprises a graphic-processing unit (GPU) 42 and a central processing unit (CPU) 70. The CPU 70 is coupled to the GPU 42, the image-resizing unit 20, and/or the at least two cameras 10. The CPU 70 may control the GPU 42, the image-resizing unit 20, and/or the at least two cameras 10.

For example, the CPU 70 may comprise at least an input and an output. The GPU 42 may be arranged to generate the at least one resizing factor. The CPU 70 may be arranged to receive via the input the at least one resizing factor from the GPU 42. The CPU 70 may be arranged to output via the output the at least one resizing factor to the image-resizing unit 20.

In another example, the GPU 42 may be arranged to generate the at least one resizing factor based on the stored at least two resized images which are resulting from a selected viewpoint. The GPU 42 may retrieve respective sizes of the stored at least two resized images which are used to generate the output image. The GPU 42 may generate the at least one resizing factor from the respective sizes. The resizing factor may for example be updated in the described manner for a selected new viewpoint.

In a further example, the at least one resizing factor may be generated by adapting an image resolution of the output image to a pixel resolution of the display 50. The pixel resolution of the display 50 may be e.g. be retrieved by the controlling unit 62.

In any of the examples described above, the image-resizing unit 20 may resize the at least two input images by using one or more resizing factors. The controlling unit 60 or the processing unit 40 of FIG. 1, or the GPU 42 of FIG. 2 may be arranged to generate a respective resizing factor for each input image. Each respective resizing factor may be different for each input image.

The CPU 70 may configure, e.g. by software instructions, the image-resizing unit 20 to resize the selected input image by e.g. the respective resizing factor.

Resizing of the at least two input image occurs “on the fly” when the at least two cameras 10 capture the at least two input images. As a consequence, the resized images, and not the input images, are accessed and processed by the processing unit 40 or the GPU 42 to generate the output image. Since the processing unit 40 or the GPU 42 uses resized images for generating the output image, transfer bandwidth from the memory 30 and towards the memory 30 may be substantially reduced. Further, resizing is dependent on the selected viewpoint, e.g., on the output image viewed from a viewpoint on the display 50. The viewpoint can e.g. be automatically selected or selected by a user.

The image resizing unit 20 may be arranged to resize the at least two input images based on a real-time selected viewpoint. For example, the image resizing unit 20 may adaptively resize the at least two input images by evaluating a real-time selected viewpoint. Each time the selected viewpoint is changed in the display 50, resizing of the at least two input images may be adapted to the changed selected viewpoint. Adapting the resizing of the input images to real-time selected viewpoints enhances memory bandwidth use e.g. for changing viewpoints over time.

For some selected viewpoint, size of the input image, e.g., its image resolution, may be superfluous. An image resolution lower than the input image resolution may be sufficient to display the output image without losing details of each of the at least two input images.

Details of one input image may either not be used in the output image or used with a lower quality, in which case a lower image resolution of the input images may be used.

For example, the processing unit 40 or the GPU 42 may be arranged to merge the at least two input images to generate the view: e.g. a first input image Pic1 and a second input image Pic2 as schematically indicated in the FIGS. 1-3. The selected viewpoint may be a zoom-in portion of the output image. The zoom-in portion may include details of the second input image Pic 2 and exclude details of the first input image Pic1. However, the zoom-in portion has a sufficient image resolution such that the details of the second input image Pic2 can be clearly seen on the display 50. The image-resizing unit 20 may resize the first input image Pic1 to a lower resolution version and output that lower resolution version to the memory 30. The memory 30 may store the lower resolution version of the first input image Pic1 and a maximum resolution version of the second input image Pic2. The processing unit 40 or the GPU 42 generates the output image from the lower resolution version of the first input image Pic1 and a maximum resolution version of the second input image Pic2. A lower memory bandwidth is used to transfer the lower resolution version of the first image Pic1 from the memory 30 to the processing unit 40 or GPU 42.

The meaning of the “selected viewpoint” is explained hereinafter.

The at least two cameras 10 may be arranged to view from at least two different adjacent views. The selected viewpoint corresponds to a selected virtual viewpoint. In response to the selected viewpoint, the at least two input images are merged. The output image may seem to be taken from a virtual camera arranged at the selected virtual viewpoint.

The at least two cameras 10 may be very wide angle cameras, e.g. fish-eye cameras. Images captured from very wide angle cameras are distorted. The processing unit 40 or the GPU 42 processes the resized images in order to remove distortion and generate a view with the desired details. Resized images rendered on the display 50 may be processed with any algorithm known in the art and suitable for the specific implementation.

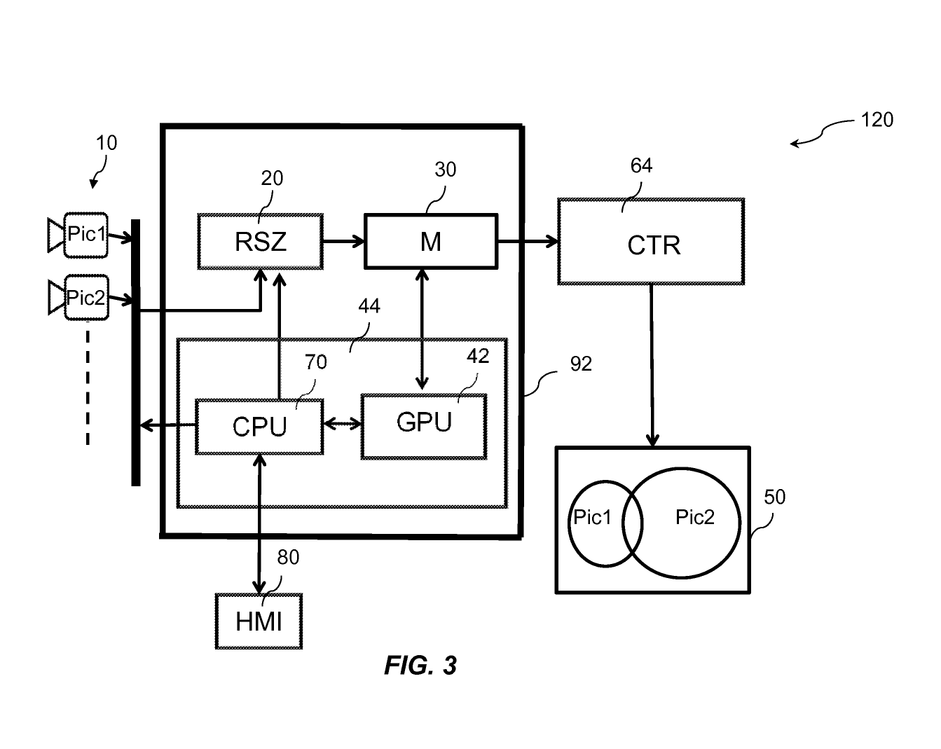

FIG. 3 schematically shows a third example of a multi-camera view system 120. The multi-camera view system 120 comprises the system controller 92, the at least two cameras 10, the display 50, the controlling unit 64 and a human machine interface (HMI) 80. The system controller 92 has already been described with reference to FIG. 2. The HMI 80 may be coupled to the CPU 70 for selecting the viewpoint.

In an example, in response to the selected viewpoint, via e.g. the HMI 80, the CPU 70 may be arranged to calculate the at least one resized factor based on geometric approximations of the displayed view and output via the output the at least resizing factor to the image resizing unit 20.

The HMI 80 may be of any type suitable for the specific implementation. For example, the HMI 80 may be integrated in the display 50 as a touchscreen interface responding to a finger and/or multi-fingers touch of the user. The HMI 80 may be implemented with buttons, joystick-like apparatuses or via a touchscreen suitable to for example scroll, zoom-in, zoom-out the output image on the display 50.

Resizing of the at least two input images may be triggered by the user selecting the viewpoint via the HMI 80. Alternatively, the viewpoint may be selected automatically by the multi-camera view system 100, 110 or 120.

The multi-camera view systems 100, 110 and 120 shown with reference to the FIGS. 1 to 3 may be used in any suitable application.

For example, any of the multi-camera view systems 100, 110, 120 may be a surround view system.

The multi-camera view system 100, 110 or 120 may be able to generate a 360 degrees output image, a two dimensional, or a three-dimensional output image.

The display 50 of the multi-camera view system 100, 110 or 120 may be arranged to view real-time video resulting from the real-time captured at least two input images.

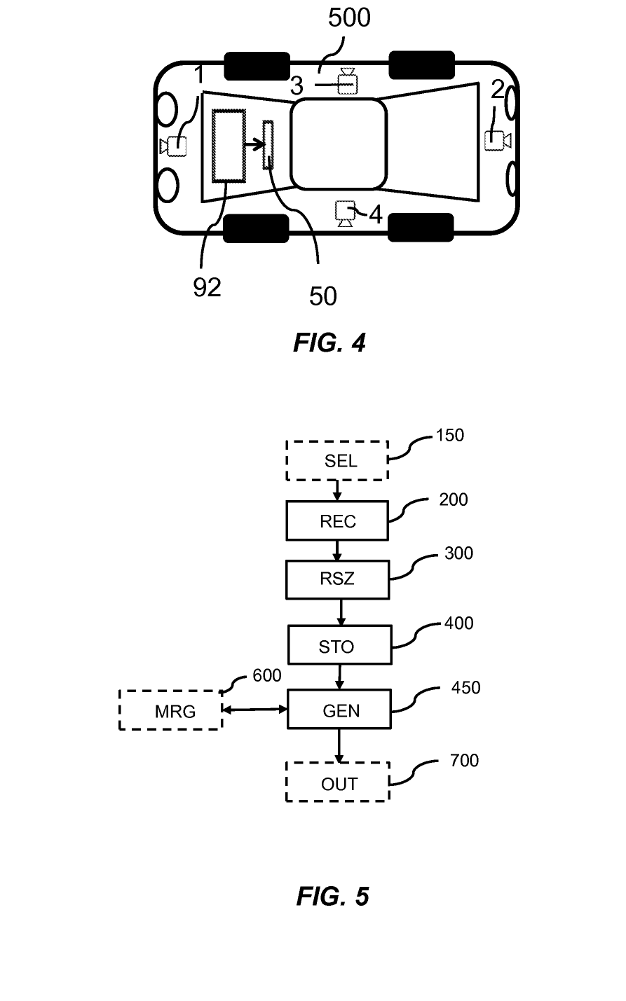

FIG. 4 shows a top view of an automotive vehicle 500.

The automotive vehicle 500 may comprise the system controller 92, the display 50 and four cameras 1, 2, 3 and 4. The display 50 may be arranged e.g. on a driver and/or passenger position in order for the driver or passenger to view the display 50 while driving. The four cameras 1, 2, 3 and 4 are arranged at sides of the automotive vehicle. The four cameras 1, 2, 3 and 4 are arranged to view each from a different viewing angle. For example as shown in FIG. 4, the cameras 1 and 2 are viewing at a front and back sides of the automotive vehicle 500, respectively. Cameras 3 and 4 are viewing at a right and left sides of the automotive vehicle 500, respectively. For example, cameras 3 and 4 may be mounted and hidden in the back mirrors (not shown in FIG. 4) of the automotive vehicle 500. The display 50 may show an output image resulting from merging the resized images captured by the four cameras 1, 2, 3 and 4. The user, e.g., the driver or the passenger, may select either to display a 360 degrees output image to see all viewing angles captured by the four cameras 1, 2, 3 and 4 or e.g. only a front view merged with a side view, or a back view merged a side view. Depending on the selected viewpoint, the resizing unit in the system controller 92 may resize the input images captured by the four cameras 1, 2, 3 and 4 to adapt the image resolutions of the resized four images to a desired level of details required in the merged output image.

The viewpoint can be selected by the driver and or passengers, or be automatically selected by a steering direction or gear position. For example, turning the steering may trigger a side view to be displayed; putting the gear into reverse may trigger a back side view to be displayed.

FIG. 5 schematically shows a flow diagram of a method of processing at least two input images for displaying an output image on a display. The output image is a view from a selected viewpoint.

The method comprises receiving 200 the at least two input images, resizing 300 the at least two input images to obtain corresponding at least two resized images based on the selected viewpoint, storing 400 the at least two resized images, generating 450 the output image from the at least two resized images. The method may comprise selecting 150 the viewpoint. The viewpoint may be selected before or after receiving the at least two resized images. The viewpoint may be selected e.g. as described with reference to FIG. 1 or FIG. 3. The method may further comprise outputting 700 the output image to the display 50, e.g. via a display controller of the controlling unit 60, 62 or 64 coupled to the display 50. Generating 450 the output image may comprise merging 600 the at least two resized images in the view. The method of processing the at least two image may be implemented with the multi-camera view systems 110, 120 or 130 or the system controllers 90 or 92 described with reference to the FIGS. 1-4 or in any manner suitable for the specific implementation.

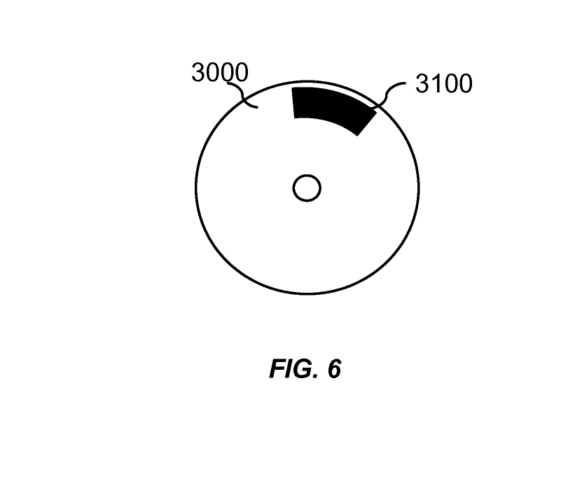

FIG. 6 shows a computer readable medium 3000 comprising a computer program product 3100, the computer program product 3100 comprising instructions for causing a programmable apparatus to perform a method of processing at least two input images for displaying an output image on a display according to any one embodiment described above. The computer program product 3100 may be embodied on the computer readable medium 3000 as physical marks or by means of magnetization of the computer readable medium 3000. However, any other suitable embodiment is conceivable as well. Furthermore, it will be appreciated that, although the computer readable medium 3000 is shown in FIG. 6 as an optical disc, the computer readable medium 3000 may be any suitable computer readable medium, such as a hard disk, solid state memory, flash memory, etc., and may be non-recordable or recordable. The computer readable medium may be a non-transitory tangible computer readable storage medium. The computer readable medium may be a non-transitory tangible computer readable storage medium comprising data loadable in a programmable apparatus, the data representing instructions executable by the programmable apparatus, said instructions comprising one or more capture instruction for capturing at least two images; one or more resize instructions for resizing the at least two images to obtain at least two resized images; one or more store for storing the at least two resized images; one or more determine instructions for determining the output image from the at least two resized images; one or more store instructions for storing the output image; one or more select instruction for selecting a combination of the at least two input images in the output image viewed in the display; one or more display instructions for displaying the output image on the display and one or more adapt instructions for adapting a resolution of the selected combination to the display resolution.

In the foregoing specification, the invention has been described with reference to specific examples of embodiments of the invention. It will, however, be evident that various modifications and changes may be made therein without departing from the scope of the invention as set forth in the appended claims.

For example, in FIGS. 1-3 the memory 30 may be any type of memory suitable for the specific implementation: e.g. a Double Data Rate (DDR) memory, a Single Data Rate (SDR) memory, a Graphics Double Data Rate (GDDR) memory, a Static Random Access Memory (SRAM) or any other suitable memory.

The graphic-processing unit 42 in FIG. 3 unit has been schematically indicated with the acronym GPU (Graphics Processing Unit). The GPU 42 may be any of a 3D GPU, a 2D raster GPU, a dedicated image merger device, a Visual Processing Unit (VPU), a media processor, a specialized image digital signal processors and so forth.

The connections may be any type of connection suitable to transfer signals from or to the respective nodes, units or devices, for example via intermediate devices. Accordingly, unless implied or stated otherwise the connections may for example be direct connections or indirect connections.

Because the apparatus implementing the present invention is, for the most part, composed of electronic components and circuits known to those skilled in the art, circuit details have not been explained in any greater extent than that considered necessary, for the understanding and appreciation of the underlying concepts of the present invention and in order not to obfuscate or distract from the teachings of the present invention.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system. The computer program may be provided on a data carrier, such as a CD-ROM or diskette, stored with data loadable in a memory of a computer system, the data representing the computer program. The data carrier may further be a data connection, such as a telephone cable or a wireless connection.

The term “program,” as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system.

Furthermore, although FIGS. 1-4 and the discussion thereof describe an exemplary architecture, this exemplary architecture is presented merely to provide a useful reference in discussing various aspects of the invention. Of course, the description of the architecture has been simplified for purposes of discussion, and it is just one of many different types of appropriate architectures that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

A computer system processes information according to a program and produces resultant output information via I/O devices. A program is a list of instructions such as a particular application program and/or an operating system. A computer program is typically stored internally on computer readable storage medium or transmitted to the computer system via a computer readable transmission medium. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

Also, the invention is not limited to physical devices or units implemented in non-programmable hardware but can also be applied in programmable devices or units able to perform the desired device functions by operating in accordance with suitable program code. Furthermore, the devices may be physically distributed over a number of apparatuses, while functionally operating as a single device. Also, devices functionally forming separate devices may be integrated in a single physical device. Also, the units and circuits may be suitably combined in one or more semiconductor devices. However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A system controller for controlling a multi-camera view system for displaying an output image on a display, the output image being a view from a selected viewpoint, the system controller comprising:
an image resizing unit for receiving the at least two input images captured by at least two cameras, the image resizing unit being arranged to output at least two resized images corresponding to the at least two input images, respectively, the image resizing unit being arranged to resize the at least two input images based on the selected viewpoint,
a memory coupled to the image resizing unit for storing the at least two resized images,
a processing unit coupled to the memory for generating the output image from the at least two resized images.

2. A system controller according to claim 1, the processing unit being arranged to generate at least one resizing factor, the image resizing unit being coupled to the processing unit for receiving from the processing unit the at least one resizing factor to resize the at least two input images.

3. A system controller according to claim 1, the display being coupled to a controlling unit for selecting the viewpoint, the controlling unit being arranged to generate at least one resizing factor based on the selected viewpoint, the image resizing unit being coupled to the controlling unit for receiving the at least one resizing factor from the controlling unit to resize the at least two input images.

4. A system controller according to claim 1, the processing unit being arranged to merge the at least two resized images in the view.

5. A system controller according to claim 1, the processing unit comprising a graphic processing unit and a central processing unit, the graphic processing unit being coupled to the memory for generating the output image from the at least two resized images, the central processing unit being coupled to the graphic processing unit, the image resizing unit and/or the at least two cameras for controlling the graphic processing unit, the image resizing unit and/or the at least two cameras.

6. A system controller according to claim 2, the graphic processing unit being arranged to generate the at least one resizing factor, the central processing unit being arranged to output the at least one resizing factor to the image resizing unit.

7. A system controller according to claim 6, the graphic processing unit being arranged to generate the at least one resizing factor based on the stored resized images resulting from the selected viewpoint.

8. A multi-camera view system comprising:
the system controller as claimed in claim 1,
at least two cameras for capturing the at least two input images, respectively,
a controlling unit coupled to the memory of the system controller,
a display coupled to the controlling unit,
the image resizing unit being coupled to the at least two cameras for receiving the at least two input images from the at least two cameras.

9. A multi-camera view system according to claim 8, the at least two cameras being arranged to view from at least two different adjacent views.

10. A multi-camera view system according to claim 8, further comprising a human machine interface coupled to the central processing unit for selecting the viewpoint.

11. A multi-camera view system according to claim 8, the output image being a two dimension, or a three dimension image, or a 360 degree surround image.

12. A multi-camera view system according to claim 8, the display being arranged to view real-time video resulting from real-time captured at least two input images.

13. An automotive vehicle comprising the system controller as claimed in claim 1.

14. A method of processing at least two input images for displaying an output image on a display, the output image being a view from a selected viewpoint, the method comprising:
receiving the at least two input images,
resizing the at least two input images to obtained corresponding at least two resized images based on the selected viewpoint,
storing the at least two resized images,
generating the output image from the at least two resized images.

15. A method as claimed in claim 14, further comprising selecting the selected viewpoint.

16. A method as claimed in claim 14, the generating comprising merging the at least two resized images in the view.

17. A method as claimed in claim 14, further comprising outputting the output image to the display.

18. A computer program product comprising instructions for causing a programmable apparatus to perform a method of processing at least two images for displaying an output image as claimed in claim 14.

19. A non-transitory tangible computer readable storage medium comprising data loadable in a programmable apparatus, the data representing instructions executable by the programmable apparatus, said instructions comprising:
one or more receive instructions for receiving the at least two input images,
one or more resize instructions for resizing the at least two input images to obtain corresponding at least two resized images based on the selected viewpoint,
one or more store instructions for storing the at least two resized images,
one or more generate instructions for generating the output image from the at least two resized images.

20. An automotive vehicle comprising the multi-camera view system as claimed in claim 8.
